(19) United States
(12) Patent Application Publication
(10) Pub. No.: US 2005/0084071 A1
(43) Pub. Date: Apr. 21, 2005

(54) Intelligent hand switch

(75) Inventors: Hartog J. Roos, Brookfield, WI (US); Patrick J. Craney, Waukesha, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(73) Assignee: CMR X-Ray, LLC, Waukesha, WI (US)

(21) Appl. No.: 10/847,033

(22) Filed: May 17, 2004

Related U.S. Application Data
(60) Provisional application No. 60/512,876, filed on Oct. 21, 2003.

(51) Int. Cl. H05G 1/66; H05G 1/56

(52) U.S. Cl. 378/114

(57) ABSTRACT

A hand switch for use with an x-ray machine includes a first switch actuator that starts the prepare sequence of the x-ray machine. Upon completion of the prepare sequence, the hand switch signals the x-ray technologist with a tactile indication that the prepare sequence checks are complete and that the machine is ready for an exposure. The hand switch has a second switch actuator that is used by the technologist to activate the exposure. During the actuation of the first and second switch actuators, the operator may maintain uninterrupted visual contact with the patient.

This application claims the benefit and priority of U.S. Provisional Pat. Ser. No. 60/512,876 filed Oct. 21, 2003.

### FIELD OF THE INVENTION

This invention relates generally to items and accessories used with x-ray machines and x-ray equipment. More particularly, it relates to a hand held switch that allows for actuation of the preparation step of an x-ray machine, for tactile confirmation that the x-ray machine is ready for exposure, and for actuation of the exposure step.

### BACKGROUND OF THE INVENTION

The use of x-ray machines as a diagnostic tool in the medical arts is well known. The x-ray machine can be used to perform a number of radiographic studies to aid in the detection of anatomical anomalies in the subject health care patient. During the use of the typical x-ray machine, the x-ray technologist is provided with an operator's console that displays information relative to the particular x-ray study to be conducted. Inherent in the task of the x-ray technologist is the proper positioning of the patient, proper setting of the x-ray exposure parameters to compensate for patient size and position, and energization of the x-ray machine to achieve irradiation of the necessary portion of the subject and exposure of the x-ray film or receiver device. Immediately prior to the energization of the x-ray machine and exposure of the x-ray film, however, the x-ray machine must perform a number of self diagnostic steps in order to complete the sequence known as the “prepare sequence.” Upon completion of the prepare sequence, the x-ray machine will then be ready for the next step in the process known as the “expose” step. At that point, the operator console will provide visual confirmation that the x-ray machine is ready for initiation of the x-ray exposure. In order to receive that information, however, the technologist's attention will be diverted away from the patient and the technologist will not be observing the patient who is the subject of the study, even if only for a brief amount of time. During that brief period of time, it is possible that the patient could move or shift position, thus increasing the risk of needed repeat exposures and increasing the risk of danger to the patient. What is needed is a device that can allow the x-ray technician to actuate the prepare sequence of the x-ray machine, receive the indication from the x-ray machine that it has successfully completed the prepare sequence, and then initiate the x-ray exposure of the patient, all without deviating visual attention away from the patient.

Accordingly, it is an object of the present invention to provide a new and useful hand switch for use with an x-ray machine that allows the operator to maintain uninterrupted visual contact with the patient from the time that the prepare sequence is initiated until the x-ray exposure is made. It is another object to provide such a hand switch that provides a tactile indication to the operator that the prepare sequence has been completed and that the x-ray exposure may be initiated. It is yet another object to provide such a hand switch that is easy to use in one hand of the operator and can be used with a wide variety of x-ray equipment. It is still another object to provide such a hand switch that requires only a minimal number of steps to use and a minimal number of elements to fabricate.

### SUMMARY OF THE INVENTION

The hand switch of the present invention has obtained these objects. It provides for a hand switch for use with an x-ray machine, the hand switch having a first switch actuator that starts the prepare sequence of the x-ray machine. Upon completion of the prepare sequence, the hand switch signals the x-ray technologist with a tactile indication that the prepare sequence checks are complete and that the machine is ready for an exposure. The hand switch has a second switch actuator that is used by the technologist to activate the exposure. During the actuation of the first and second switch actuators, the operator may maintain uninterrupted visual contact with the patient.

The foregoing and other features of the present invention will be apparent from the detailed description that follows.

### BRIEF DESCRIPTION OF THE DRAWINGS

FIG. 1 is a generalized perspective view showing a hand switch that is constructed in accordance with the present invention being used in a radiological study.

FIG. 2 is a front, top and right side perspective view of a hand switch constructed in accordance with the present invention.

FIG. 3 is a right side elevational and cross sectioned view of the hand switch shown in FIG. 2.

FIG. 3 is a schematic electrical diagram of the switch circuitry used in the hand switch of the present invention.

### DETAILED DESCRIPTION

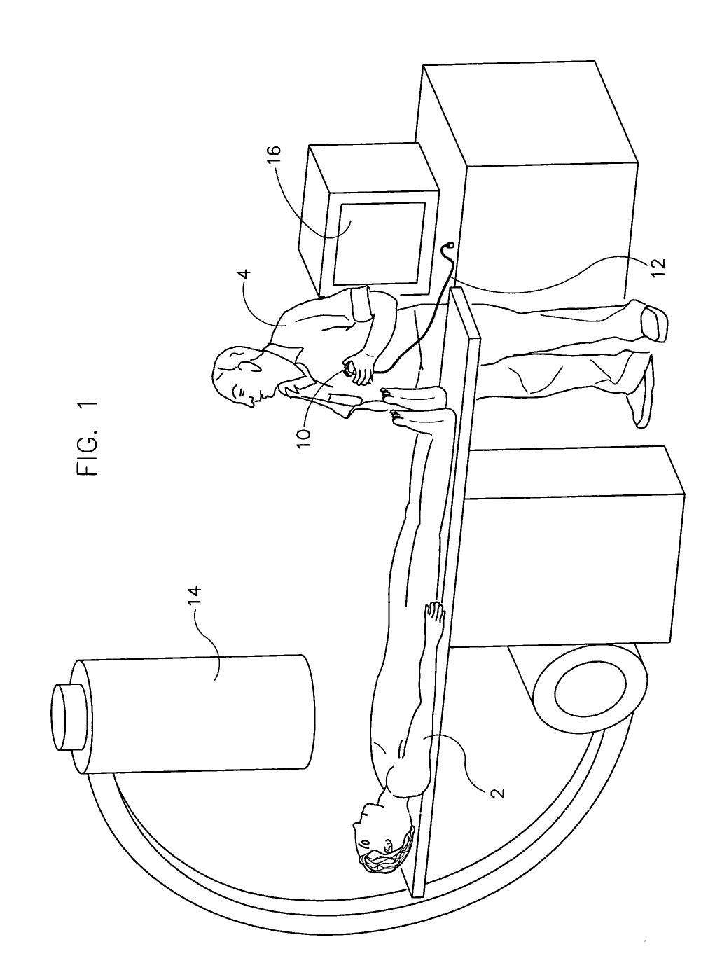

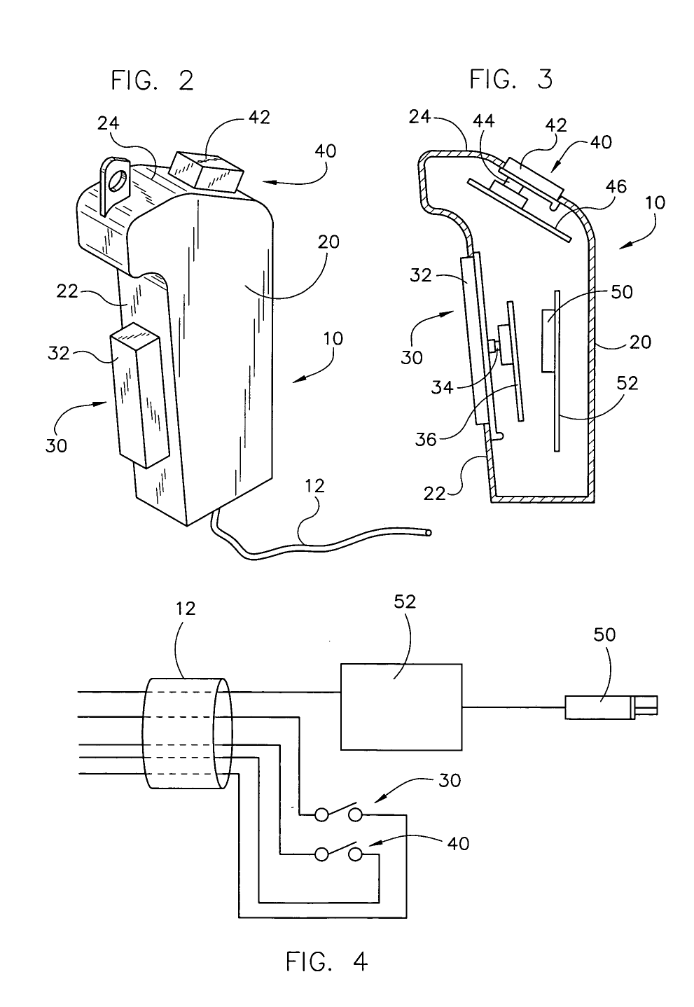

Referring now to the drawings in detail wherein like numbers represent like elements throughout, FIG. 2 illustrates a perspective view of one embodiment of the hand switch, generally identified 10, constructed in accordance with the present invention. As shown in FIG. 1, the hand switch 10 is used in conjunction with an x-ray machine 14 and an operator's console 16, the hand switch 10 being electrically connected by means of a hand switch cord 12. The hand switch 10 includes a housing 20, a first switch actuator 30, and a second switch actuator 40. In the preferred embodiment, the housing 20 is comprised of two opposing housing shells (not shown) that are attached to one another by use of self-threading fasteners (also not shown). It is to be clearly understood, however, that the housing 20 could be configured differently without deviating from the scope of this invention.

As shown, the housing 20 of the preferred embodiment is generally formed as a hand grip and includes a forward grip portion 22 and an upper grip portion 24. Here again, it is to be understood that the precise shape of the housing 20 is not a limitation of the present invention.

Located within the forward grip portion 22 of the housing 20 of the hand switch 10 of the present invention is the first switch actuator 30. Located within the upper grip portion 24 of the housing 20 is the second switch actuator 40. The first switch actuator 30 includes an actuator button 32 that is urged outwardly of the housing 20 by means of a spring means 34. See FIG. 3. A first switch actuator switch board 36 is located immediately below the spring means 34 and button 32 of the first switch actuator 30. When the button 32 of the first switch actuator 30 is depressed, typically by one or more of the operator's fingers, the spring means 34 is compressed and actuates the switch board 36 to close an electrical circuit within the hand switch 10. See also FIG. 4. Similarly, the second switch actuator 40 includes an actuator button 42 that is urged outwardly of the housing 20 by means of a spring means 44. A second switch actuator switch board 46 is located immediately below the spring means 44 and button 42 of the first switch actuator 40. When the button 42 of the first switch actuator 40 is depressed, typically by the operator's thumb, the spring means 44 is compressed and actuates the switch board 46 to close another electrical circuit within hand switch 10.

In the hand switch 10 of the present invention, a vibrating motor 50 and a vibrating motor timer circuit 52 are situated within the housing 20 as well. The vibrating motor 50 is an offset cam type vibrator of conventional manufacture. The vibrating motor timer 52 provide the hand switch 10 with the ability to time out the amount of time that the motor 50 will vibrate. In the preferred embodiment, this amount of time is on the order of one second. It is to be understood, however, that the precise amount of time and the exact mechanism for providing a tactile signal to the user is not a limitation of the present invention.

In application, the x-ray technologist operator 4 will set the field of view desired relative to the patient 2, the study desired and the operating parameters of the x-ray machine 14. Once everything relative to the patient view to be take is in place, the operator 4 will use the hand switch 10 to prepare the x-ray machine 14. The prepare sequence is started by closing and holding closed the first switch actuator 30. This is accomplished by pushing and holding in the first switch actuator button 32 located at the forward grip portion 22 of the housing 20. During the prepare period, the x-ray machine 14 automatically checks various electrical circuits for safety and operational status. When the prepare period is complete, and no problems are found, the x-ray machine 14 will be ready for exposure.

In existing art, and typically at the completion of the prepare sequence, a lamp located on the operator's console 16 will illuminate, thereby indicating that the x-ray machine 14 is ready for the initiation of the x-ray exposure. When the x-ray technologist 4 observes that the lamp is lit, and determines that the patient 2 continues to be properly positioned, the x-ray exposure is initiated by closing the second switch actuator 40 located at the upper grip portion 25 of the housing 20. While closing these switch actuators 30, 40, the x-ray technologist 4 must insure that the patient 2 remains positioned correctly so that when x-ray radiation is produced the proper anatomy is imaged.

In the hand switch 10 of the present invention, a significantly different procedure occurs. At the completion of the prepare cycle, the hand switch 10 of the present invention signals the x-ray technologist 4 with a tactile indication that the x-ray machine 14 is ready for an exposure. As alluded to earlier, this is done by incorporating a small vibrating motor 50 into the hand switch 10. The motor 50 starts vibrating when the prepare sequence is complete and the machine 14 is ready for x-ray exposure. The vibration lasts a short time, approximately one second. This is long enough to give the operator an indication that prepare checks are complete. The advantage of this tactile signal is that the x-ray technologist 4 does not have to watch the operator's console 16 to determine that the machine 14 has successfully completed the prepare cycle. In this way, the technologist 4 can continually observe the patient 2 without having to look at the operator's console 16. This improves patient safety and minimizes the need to repeat x-ray exposures in the event that the patient 2 moves before or during the exposure.

Based upon the foregoing, it will be seen that there has been provided a new and useful hand switch for use with an x-ray machine that allows the operator to maintain uninterrupted visual contact with the patient from the time that the prepare sequence is initiated until the x-ray exposure is made; that provides a tactile indication to the operator that the prepare sequence has been completed and that the x-ray exposure may be initiated; that is easy to use in one hand of the operator and can be used with a wide variety of x-ray equipment; and that requires only a minimal number of steps to use and a minimal number of elements to fabricate.

The principles of this invention having been fully explained in connection with the foregoing,

1. A hand switch for use by an operator of an x-ray machine which comprises
a housing,
a first switch actuator for activating a prepare sequence for the x-ray machine,
a second switch actuator for activating x-ray exposure by the x-ray machine, and
a tactile indicator for informing the operator that the prepare sequence has been completed and that the x-ray machine is ready to be activated for exposure.

2. The hand switch of claim 1 wherein the first switch actuator includes a depressible first switch button.

3. The hand switch of claim 1 wherein the second switch actuator includes a depressible second switch button.

4. The hand switch of claim 2 wherein the first switch button is spring loaded to urge the button outwardly of the housing.

5. The hand switch of claim 3 wherein second switch button is spring loaded to urge the button outwardly of the housing.

6. The hand switch of claim 1 wherein the first switch actuator is electrically connected to the x-ray machine to initiate the prepare sequence for the machine.

7. The hand switch of claim 6 wherein the tactile indicator is electrically connected to the x-ray machine to be activated upon completion of the prepare sequence.

8. The hand switch of claim 7 wherein the tactile indicator is a vibrating motor.

9. A hand switch for use with an x-ray machine, said machine having electrical circuitry for conducting a prepare sequence whereby various electrical circuits are checked for safety and operational status, which comprises
a prepare switch for activating the prepare sequence,
means for sensing completion of the prepare cycle,
means for actuating a tactile signal upon completion of the prepare sequence, and
an expose switch for activating x-ray exposure by the machine.

10. The hand switch of claim 9 including a housing wherein the prepare switch includes a prepare switch button that is depressible into the housing.

11. The hand switch of claim 9 including a housing wherein the expose switch includes an expose switch button that is depressible into the housing.

12. The hand switch of claim 10 wherein the prepare switch button is spring loaded to urge the button outwardly of the housing.

13. The hand switch of claim 11 wherein expose switch button is spring loaded to urge the button outwardly of the housing.

14. The hand switch of claim 9 wherein the prepare switch is electrically connected to the x-ray machine to initiate the prepare sequence for the machine.

15. The hand switch of claim 14 wherein the tactile indicator is electrically connected to the x-ray machine so as to be activated upon completion of the prepare sequence.

16. The hand switch of claim 15 wherein the tactile indicator is a vibrating motor.
